(19) United States
(12) Patent Application Publication
(10) Pub. No.: US 2026/0205540 A1
(43) Pub. Date: Jul. 16, 2026

(54) Artificial Intelligence Enhanced Interactive Voice Response (IVR) with Quantum Security and Dynamic Fraud Prevention

(71) Applicant: Bank of America Corporation, Charlotte, NC (US)

(72) Inventors: Adam King, Fort Mill, SC (US); James Siekman, Charlotte, NC (US); Andrew S. Thomas, Abingdon, MD (US); Jada Williams, Baltimore, MD (US); Kevin Sweeney, Brookhaven, PA (US); Ilya Goussev, Woodstock, GA (US); Dawn Turner, Carrollton, TX (US); Robert James Hepp, Timonium, MD (US); Charlene Gorter, Charlotte, NC (US); Crystine Peebles, Newark, DE (US); Tiara Fry, Denver, CO (US); Clara Fritts, Washington, DC (US)

(73) Assignee: Bank of America Corporation, Charlotte, NC (US)

(21) Appl. No.: 19/021,746

(22) Filed: Jan. 15, 2025

(51) Int. Cl. H04M 3/22; G06V 40/16; H04L 9/08; H04M 3/51

(52) U.S. Cl. CPC H04M 3/2281; H04L 9/0852; H04M 3/5166; G06V 40/174; H04M 2201/40

(57) ABSTRACT

A highly secure and adaptive Interactive Voice Response (IVR) system and method that integrates artificial intelligence, Quantum Key Distribution (QKD), and dynamic fraud prevention is disclosed herein. An Artificial Intelligence (AI) component may continuously analyze caller behavior, including speech patterns, emotional indicators, and potential scripted dialogue, to detect anomalies in real-time. The system and method may adapt IVR pathways based on these analyses, directing suspicious calls into secure environments for further investigation. Quantum encryption may safeguard all communication channels, ensuring that data transmission remains secure and tamper-evident, and electronic countermeasures may disrupt malicious actors non-destructively.

### FIELD OF USE

Aspects of the disclosure relate to systems and processes for the prevention of unauthorized access to resources and applications of a system or information transaction system, including the manner of identifying, authorizing, and verifying the entity, process, or mechanism requesting access to the resource and application. Specifically, Interactive Voice Response (IVR) systems and related processes and methods, and more specifically, those enhanced with artificial intelligence for real-time fraud prevention, quantum encryption for secure communication, and adaptive mechanisms to dynamically thwart evolving threats.

### BACKGROUND

Traditional IVR systems are increasingly vulnerable to sophisticated fraud techniques such as caller ID spoofing, scripted bot attacks, and unauthorized access attempts. These systems use static pathways and standard encryption, which fail to provide adequate security against evolving threats. As fraudsters become more sophisticated, a need has arisen for an IVR system capable of adaptive learning, quantum-secure communications, and real-time threat neutralization.

It would be advantageous to organizations to utilize the IVR systems, processes, and methods disclosed herein that may integrate artificial intelligence (AI) for real-time voice analysis and machine learning to detect fraud resulting in a dynamic response using non-destructive countermeasures to neutralize malicious actors and attacks.

### SUMMARY

In light of the foregoing background, the following presents a simplified summary of the present disclosure in order to provide a basic understanding of various aspects of the disclosure. This summary is not limiting with respect to the exemplary aspects of the inventions described herein and is not an extensive overview of the disclosure. It is not intended to identify key or critical elements of the disclosure or to delineate the scope of the disclosure. Instead, as would be understood by a personal of ordinary skill in the art, the following summary merely presents some concepts of the disclosure in a simplified form as a prelude to the more detailed description provided below.

In one general aspect of this disclosure, a system of one or more computer executable software and data, computer machines and components thereof, networks, and/or network equipment can be configured to perform particular operations or actions individually, collectively, or in a distributed manner to cause the system or components thereof to analyze voice data in real-time to detect fraud and to employ non-destructive countermeasures to neutralize malicious actors and attacks using integrated artificial intelligence and machine learning.

In one aspect of the disclosure, a secure and adaptive Interactive Voice Response system for detecting and mitigating fraudulent activities in real-time may include an Artificial Intelligence analysis engine configured to evaluate caller voice data to identify malicious bots and to detect fraud indicators via fraud detection algorithms, a dynamic IVR pathway configured to modify caller navigation routes to isolate calls with detected fraud indicators in real-time, an electronic countermeasure mechanism configured to disrupt the malicious bots, a feedback and adaptation mechanism configured to refine the AI analysis engine and related fraud detection algorithms utilizing machine learning, and a Quantum Key Distribution module configured to provide secure communications within the system.

In some examples, the caller voice data may include voice tone, voice speed, voice volume, voice patterns indicative of psychological stress, anxiety, hesitation, or combinations thereof. In other examples the caller voice data may be compared to a known customer profile to detect fraud. In one example, the caller voice data may be compared to known fraudulent profiles to detect fraud. In another example, the AI analysis engine may be further configured to perform behavioral pattern recognition that may compare a known customer profile to a known fraudulent profile to distinguish between a legitimate caller and a malicious caller. In yet other examples, the modified caller navigation routes may prevent a fraudster from attacking predictable navigation paths by confusing and trapping the fraudster in a complex loop. In yet another example, the electronic countermeasure mechanism may be configured to emit a targeted high-frequency signal to disable the malicious bots. In still other examples, the targeted high-frequency signal does not impact or harm a human caller. In other examples, the system may also include a sensor configured to detect caller facial expressions. In yet another example, the AI analysis engine may be further configured to identify detected caller facial expressions comprising fraud indicators.

In another aspect of the disclosure, a method or process of fraud protection in an IVR system may include the steps of receiving an incoming call from a caller via the IVR system and initiating an analysis of a caller voice data via an AI engine, processing the caller voice data to identify malicious bots and to identify fraud indicators via fraud detection algorithms, modifying caller navigation routes to isolate calls with detected fraud indicators in real-time via a dynamic IVR pathway, disrupting identified malicious bots via an electronic countermeasure mechanism, refining the AI engine and related fraud detection algorithms via a feedback and adaptation mechanism utilizing machine learning, encrypting communications between the caller and the IVR system using quantum key distribution, and storing the detected fraud indicators via a quantum-encrypted database.

In some examples, the caller voice data may include voice tone, voice speed, voice volume, voice patterns indicative of psychological stress, anxiety, or hesitation, or combinations thereof. In other examples, the caller voice data may be compared to a known customer profile to detect fraud. In one example, the caller voice data may be compared to known fraudulent profiles to detect fraud. In some examples, the electronic countermeasure mechanism may be configured to emit a targeted high-frequency signal to disable the malicious bots. In another example, the targeted high-frequency signal does not impact or harm a human caller. In still other examples, the human caller cannot hear the targeted high-frequency signal. In yet other example, the method or process may further include the step of detecting, via a sensor, caller facial expressions. In one example, the AI analysis engine may be further configured to identify detected caller facial expressions comprising fraud indicators.

In another aspect, a method for securing IVR systems may include AI-based real-time analysis of speech and behavioral patterns and dynamically adjusting call pathways to prevent fraud is disclosed herein.

In yet another aspect, an IVR system may utilize Quantum Key Distribution for secure communications to ensure immediate detection of any interception attempt is disclosed herein.

In other aspects, a method of fraud prevention in IVR systems may incorporate anomaly detection and sandbox routing to isolate and analyze suspicious calls is disclosed herein.

In another aspect, an electronic countermeasure system for IVR may emit targeted frequencies to neutralize malicious bots without harming legitimate interactions is disclosed herein.

In yet other aspects, a continuous learning framework for IVR systems may update fraud detection algorithms using real-time and/or historical data is disclosed herein.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 illustrates a secure and adaptive Interactive Voice Response system for detecting and mitigating fraudulent activities in real-time according to one or more aspects of the disclosure.

FIG. 2 depicts a flow chart for a method or process for detecting and mitigating fraudulent activities in real-time in an Interactive Voice Response system according to one or more aspects of the disclosure.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. In addition, it is to be understood that the phraseology and terminology used herein are for the purpose of description and should not be regarded as limiting. Rather, the phrases and terms used herein are to be given their broadest interpretation and meaning. As used throughout this disclosure, any number of computers, machines, or the like can include one or more general-purpose, customized, configured, special-purpose, virtual, physical, and/or network-accessible devices such as: administrative computers, application servers, clients, cloud devices, clusters, compliance watchers, computing devices, computing platforms, controlled computers, controlling computers, desktop computers, distributed systems, enterprise computers, instances, laptop devices, monitors or monitoring systems, nodes, notebook computers, personal computers, portable electronic devices, portals (internal or external), servers, smart devices, streaming servers, tablets, web servers, and/or workstations, which may have one or more application specific integrated circuits (ASICs), microprocessors, cores, executors etc., for executing, accessing, controlling, implementing etc., various software, computer-executable instructions, data, modules, processes, routines, or the like as discussed below.

References to computers, machines, or the like as in the examples above are used interchangeably in this specification and are not considered limiting or exclusive to any type(s) of electrical device(s), or component(s), or the like. Instead, references in this disclosure to computers, machines, or the like are to be interpreted broadly as understood by skilled artisans. Further, as used in this specification, computers, machines, or the like also include all hardware and components typically contained therein such as, for example, ASICs, processors, executors, cores, etc., display(s) and/or input interfaces/devices, network interfaces, communication buses, or the like, and memories or the like, which can include various sectors, locations, structures, or other electrical elements or components, software, computer-executable instructions, data, modules, processes, routines etc. Other specific or general components, machines, or the like are not depicted in the interest of brevity and would be understood readily by a person of skill in the art.

As used throughout this disclosure, software, computer-executable instructions, data, modules, processes, routines, or the like can include one or more: active-learning, algorithms, alarms, alerts, applications, application program interfaces (APIs), artificial intelligence, approvals, asymmetric encryption (including public/private keys), attachments, big data, blockchains, blocks, CRON functionality, daemons, databases, datasets, datastores, DeFi functionality, drivers, data structures, deep learning modules (e.g., knowledge graphs, NLP, LSTM, GAN, etc.), emails, extraction functionality, file systems or distributed file systems, firmware, governance rules, graphical user interfaces (GUI or UI), images, instructions, interactions, Java jar files, Java Virtual Machines (JVMs), juggler schedulers and supervisors, load balancers, load functionality, machine learning (supervised, semi-supervised, unsupervised, or natural language processing), metadata, middleware, modules, namespaces, objects, operating systems, optimization modules, platforms, processes, protocols, programs, rejections, routes, routines, rule deployment modules, security, scripts, tables, tools, transactions, transformation functionality, user actions, user interface codes, utilities, web application firewalls (WAFs), web servers, web sites, etc.

The foregoing software, computer-executable instructions, data, modules, plugins, processes, routines, or the like can be on tangible computer-readable memory (local, in network-attached storage, be directly and/or indirectly accessible by network, removable, remote, cloud-based, cloud-accessible, etc.), can be stored in volatile or non-volatile memory, and can operate autonomously, on-demand, on a schedule, spontaneously, proactively, and/or reactively, and can be stored together or distributed across computers, machines, or the like (e.g., in a decentralized network that may include a consortium of networks, entities, institutions, etc.) including memory and other components thereof. Some or all the foregoing may additionally and/or alternatively be stored similarly and/or in a distributed manner in any network of accessible storage.

As used throughout this disclosure, computer “networks,” topologies, or the like can include one or more local area networks (LANs), wide area networks (WANs), the Internet, clouds, wired networks, wireless networks, digital subscriber line (DSL) networks, frame relay networks, asynchronous transfer mode (ATM) networks, virtual private networks (VPN), or any direct or indirect combinations of the same. They may also have separate interfaces for internal network communications, external network communications, and management communications. Virtual IP addresses (VIPs) may be coupled to each if desired. Networks also include associated equipment and components such as access points, adapters, buses, ethernet adaptors (physical and wireless), firewalls, hubs, modems, routers, and/or switches located inside the network, on its periphery, and/or elsewhere, and software, computer-executable instructions, data, modules, processes, routines, or the like executing on the foregoing. Network(s) may utilize any transport that supports HTTPS or any other type of suitable communication, transmission, and/or other packet-based protocol.

As used throughout this disclosure, computer-executable “software and data” can include one or more: algorithms, applications, databases, datasets (e.g., historical datasets), drivers, data structures, firmware, graphical user interfaces, instructions, machine learning (i.e., supervised, semi-supervised, reinforcement, and unsupervised), middleware, modules (i.e., machine learning module, objects, operating systems, processes, programs, scripts, tools, and utilities). The computer-executable software and data is stored in tangible, non-volatile, computer-readable memory (locally or in network-attached storage) and can operate autonomously, on-demand, on a schedule, and/or spontaneously. “Computer machines,” (i.e., computing device, processor, etc.) can include one or more: general-purpose or special-purpose network-accessible client device, personal computers, desktop computers, laptop or notebook computers, distributed systems, workstations, portable electronic devices, cellular phone, printers, scanners, facsimile machines, multifunction devices, and/or servers having one or more microprocessors for executing or accessing the computer-executable software and data. Computer machines also includes all hardware and components typically contained therein. The “servers” can be virtual or physical, on-premise or remote, and can include one or more: application servers, cybersecurity servers, test servers, and/or web servers for executing, accessing, and/or storing the computer-executable software and data. Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of any of the same. Networks also include associated “network equipment” such as access points, ethernet adaptors (physical and wireless), firewalls, hubs, modems, routers, and/or switches located inside the network and/or on its periphery, as well as software executing on any of the foregoing.

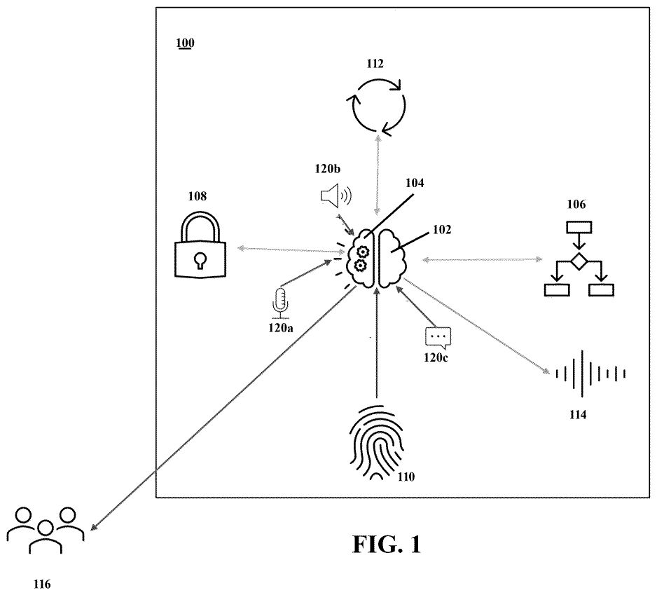

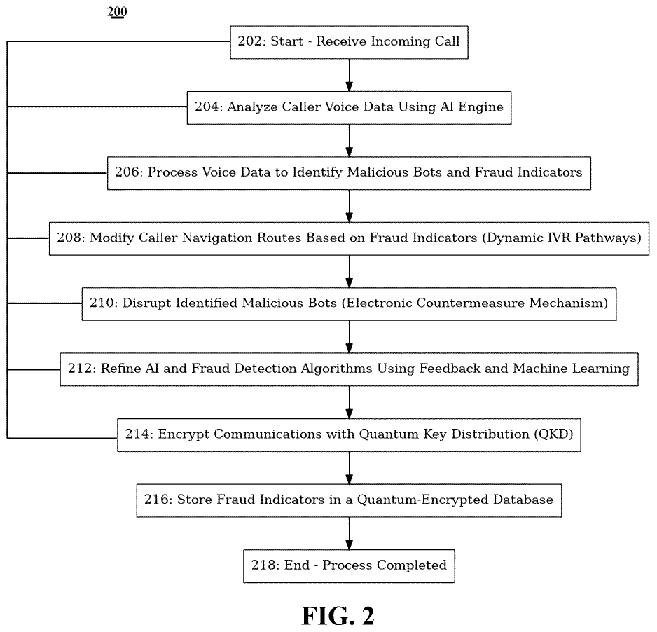

Any of the devices and systems described herein may be implemented, in whole or in part, using one or more computer machines or computing machines described with respect to FIGS. 1 and 2.

Some or all of the data described herein may be stored using any of a variety of data storage mechanisms, such as databases. These databases may include, but are not limited to relational databases, hierarchical databases, distributed databases, in-memory databases, flat file databases, XML databases, NoSQL databases, graph databases, and/or combinations thereof. The data transferred to and from various computer machines may include secure and sensitive data, such as confidential documents, customer personally identifiable information, voice data, and account data. It may be desirable to protect transmissions of such data using secure network protocols and encryption and/or to protect the integrity of the data when stored on the various computer machines. For example, a file-based integration scheme or a service-based integration scheme may be utilized for transmitting data between the various computer machines. Data may be transmitted using various network communication protocols. Secure data transmission protocols and/or encryption may be used in file transfers to protect the integrity of the data, for example, File Transfer Protocol (FTP), Secure File Transfer Protocol (SFTP), and/or Pretty Good Privacy (PGP) encryption. In many embodiments, one or more web services may be implemented within the various computer machines. Web services built to support a personalized display system may be cross-domain and/or cross-platform, and may be built for enterprise use. Data may be transmitted using the Secure Sockets Layer (SSL), Transport Layer Security (TLS) protocols or Quantum Key Distribution to provide secure connections between the computer machines. Web services may be implemented using the WS-Security standard, providing for secure SOAP messages using XML encryption. Specialized hardware may be used to provide secure web services. For example, secure network appliances may include built-in features such as hardware-accelerated SSL and HTTPS, WS-Security, and/or firewalls. Such specialized hardware may be installed and configured in front of one or more computer machines such that any external devices may communicate directly with the specialized hardware.

By way of introduction, aspects discussed herein relate to the novel integration of quantum encryption, adaptive AI, and real-time bot disruption to improve IVR security. Current systems do not offer the level of adaptability, predictive analytics, or quantum-secure communication described in the present disclosure. Moreover, the sandboxing mechanism and non-destructive electronic countermeasures disclosed herein are also novel features that enhance system robustness against evolving threats.

Interactive Voice Response (IVR) is an automated telephonic system that interacts with callers, gathers information, and routes calls to the appropriate recipient. IVR may uses pre-recorded voice prompts and menus to present options, allowing users to respond using voice commands or touch-tone keypad inputs (dual-tone multi-frequency signaling (DTMF) signals). IVR systems can handle a high volume of incoming calls without requiring human agents. Callers can navigate through different options in a structured menu to resolve issues or access information. The system may collect data such as account numbers, PINs, and other inputs to authenticate users and process requests. IVR may connect with backend systems/servers to provide real-time information, such as account balances, transaction details, appointment scheduling, etc. Based upon user inputs, IVR may route a user/caller to specific departments, agents, automated processes, etc.

The operation of IVR initiates when a caller dials a phone number in communication with a particular the system. The system may greet the caller and present a menu of options or commands. Callers provide inputs either through speech recognition or by pressing numbers on their phone or cellular device keypad. The IVR processes the input and may provide automated responses or may route the call to an agent. Depending on the selected input, actions such as providing information, executing a transaction, or forwarding the call may be executed.

IVR is widely used in industries such as banking, customer support, other services, surveys, marketing campaigns, etc. In banking services, IVR may assist with balance inquiries, transfers, account information, etc. In customer support, IVR may assist with ticket booking, troubleshooting, FAQs, etc. In other settings, IVR may facilitate appointment scheduling and reminders. IVR may also be employed for conducting automated customer satisfaction surveys and delivering promotional messages or offers in marketing.

The advantages of IVR include its ability to operate 24/7 without human intervention, reducing the need for live agents thus lowering operational costs. IVY may improve customer experiences by offering self-service options for faster resolution of a problem and may be scalable to handle larger call volumes.

Despite its benefits, IVR systems also present several disadvantages that can impact user satisfaction and effectiveness. One major drawback is the complexity of menu structures, which can lead to confusion and frustration for callers who struggle to find the appropriate options. Users may feel trapped in endless loops or experience delays when trying to speak to a live agent. Furthermore, IVR systems are often inflexible and lack the ability to handle queries or issues outside their programmed scope, making it difficult to resolve unique or complex problems. Speech recognition technology, while improving, is still prone to errors, particularly in noisy environments or with callers who have accents or speech impairments. These inaccuracies can lead to misinterpretations and force callers to repeat information multiple times, further aggravating their experience. Additionally, reliance on automated responses can sometimes feel impersonal, leading to dissatisfaction among users who prefer human interaction. These limitations highlight the need for continuous improvements and enhancements to IVR systems to better meet user expectations.

Critically, IVR systems are also vulnerable to hacking, posing security risks that may compromise sensitive data and system integrity. Hackers can take advantage of weaknesses in IVR systems through methods such as Caller ID spoofing, where attackers disguise their identity to impersonate legitimate users and gain unauthorized access. Hackers may also use brute force attacks to guess PINs or account numbers, leveraging automated tools to test multiple combinations quickly. Social engineering tactics, such as phishing calls, can manipulate IVR systems or deceive customer service agents into disclosing confidential information. Additionally, attackers may find vulnerabilities in the IVR's integration with backend databases, leading to unauthorized data extraction or system manipulation. These vulnerabilities highlight the need for robust security measures, including encryption, multi-factor authentication, anomaly detection systems, and regular updates to safeguard IVR systems from evolving threats.

Additionally, bots pose a significant threat to IVR systems due to their ability to automate and scale attacks, making them highly effective at finding and taking advantage of vulnerabilities. Malicious bots can flood IVR systems with automated calls, overwhelming the infrastructure and causing service disruptions through a type of attack known as Telephony Denial of Service (TDoS). These bots can mimic human interactions, bypassing basic security measures and accessing sensitive information through brute force attacks or discovering poorly secured menu options. Bots can also be programmed to repeatedly test PINs, passwords, and account numbers, increasing the risk of unauthorized access. Additionally, advanced bots equipped with AI and machine learning capabilities can adapt to responses, making them harder to detect and mitigate. Such attacks not only compromise data security, but also degrade service quality, leading to frustration for legitimate customers and financial losses for businesses.

To counter these threats, the systems and methods disclosed herein introduce a highly secure and adaptive IVR system that integrates artificial intelligence, Quantum Key Distribution (QKD), and dynamic fraud prevention. The AI component continuously analyzes caller behavior, including speech patterns, emotional indicators, and potential scripted dialogue, to detect anomalies in real-time. The system adapts IVR pathways based on these analyses, directing suspicious calls into secure environments for further investigation. Quantum encryption safeguards all communication channels, ensuring that data transmission remains secure and tamper-evident. Additionally, electronic countermeasures can disrupt malicious bots non-destructively.

As shown in FIG. 1, a secure and adaptive Interactive Voice Response system 100 for detecting and mitigating fraudulent activities in real-time may include a core module or core processing unit 102 configured to perform real-time processing of all incoming calls to detect potential fraud. AI engine 104 may be in communication with core processing unit 102 and may use algorithms for speech-to-text conversion, sentiment analysis, behavioral assessment, etc. Calls identified as suspicious by AI engine 104 may be rerouted to a secure isolation sandbox for further analysis, allowing IVR system 100 to investigate potential fraud without affecting the main communication flow in IVR system 100. IVR system 100 may further include dynamic IVR decision tree(s) 106 configured to utilize machine learning to alter caller navigation based on detected threats. If anomalies are identified or detected, the caller may be directed through a secure route or flagged for further review. Quantum Key Distribution module 108 may configured for data encryption to ensure end-to-end encryption of all communications with the caller, applying quantum encryption to prevent interception. Any tampering or malicious attack may be detectable due to the properties of quantum key distribution. IVR system 100 may further include a secure isolation sandbox 110 configured with fraud detection and routing protocols. Calls identified as suspicious by the AI engine may be rerouted to secure isolation sandbox 110 for further analysis, allowing IVR system 100 to investigate potential fraud without affecting the main communication flow.

IVR system 100 may also include electronic counter measure mechanism 114 configured to emit targeted high-frequency sounds to disrupt interactions initiated by bots without affecting human callers. Feedback and adaption mechanism 112 may be configured to collect real-time data from each call interaction to improve the fraud detection algorithms of AI engine 104 based on new fraud patterns, ensuring adaptability to emerging threats.

Core module/processing unit 102 may be configured as a hub for analyzing caller 116 interactions and adapting IVR pathways. AI engine 104 may be in communication with core module 102 and may be configured to process a caller's inputs to include real-time voice 120a analysis, voice behavioral/sentiment 120b analysis, and/or biometric voiceprint 120c analysis of a caller 116. AI engine 104 may use algorithms for speech-to-text conversion, sentiment analysis, behavioral assessment, and biometric voiceprint analysis. AI engine 104 may identify emotional cues such as stress or hesitation that might indicate fraudulent intent. Speech and sentiment analysis, and biometric voiceprint analysis algorithms may employ deep neural networks to convert speech to text, to perform sentiment analysis, and to identify emotional states such as stress or hesitancy, as previously discussed, that may indicate fraud. AI engine 104 may also use voice behavioral pattern recognition algorithms to analyze caller voice data for anomalies compared to known caller profiles leveraging emotional intelligence to flag deviations typical of fraudulent activity.

AI engine 104 may continuously learn from caller interactions making real-time decisions on whether to reroute, investigate, or approve caller transactions. Input from user/client systems 116 may be analyzed in real-time using natural language processing algorithms to detect anomalies like stress, hesitation or adherence to the prewritten scripts. Risk scores may be assigned to detected speech pattern models. For example, a scripted speech common in attacks or scams can trigger elevated security protocols and may be embedded in the IVR system 100 back end. The speech models can run alongside standard voice recognition software and can compare caller data against legit customer profiles and detect deviations or anomalies. In another example, a caller may impersonate a known customer and the caller will hesitate when verifying security questions and the IVR system 100 and AI engine 104 will detect the hesitation and alert the IVR dynamic decision tree 106 to modify the IVR pathway to isolate that caller for further scrutiny and analysis.

In contrast to typical artificial intelligence systems that focus on operational efficiency and basic information retrieval, the system and methods disclosed herein comprehensively assess the emotional and/or psychological states of a call to provide a deeper layer of interaction analysis critical for detecting deceit and ensuring transactional security. Moreover, as discussed above, the systems and methods disclosed herein may incorporate emotional intelligence algorithms configured to analyze variations in voice tone, speed, and volume that indicate psychological stress, anxiety, or hesitation. In another example, the systems and methods disclosed herein may include facial micro-expression analysis by integrating real-time video analytics to observe facial micro-expressions comprising subtle facial muscle movements that reveal underlying emotions, such as fleeting expressions of worry or doubt not apparent in a normal interaction that are indicative of fraud. Again, by utilizing deep learning, IVR system 100 can interpret the conversation context of a caller and compare this to historical (i.e., stored) data to recognize patterns of speech or behavior associated with deceitful intentions. This could include detecting rehearsed or unnatural speech patterns often used in scripted fraud attempts. In one example, real-time biometric voice authentication may also be enhanced with emotional analysis to detect subtle stress indicators. In yet another example, a predictive AI model may be used to identify emerging fraud trends before they manifest within the IVR environment.

As shown in FIG. 1, dynamic decision tree 106 may include dynamically adjustable pathways, and may utilize machine learning to alter caller navigation based on detected threats. As described above, if anomalies are identified, the caller is directed through a secure route or flagged for further review. Dynamic decision tree 106 may be configured with adaptive learning utilizing reinforcement learning models to adapt IVR system pathways that modifies a caller's navigation experience based on detected risks. Dynamic decision tree 106 may also recognize recurring threat patterns and can update IVR system pathways to reduce predictability and to prevent attacks. As previously noted, suspicious calls can be routed to secure, isolated environments (e.g., sandbox 110) for analysis without risking primary data channels. Further, by using reinforcement learning algorithms, the dynamic decision tree 106 can adapt the decision pathways dynamically thus evolving based on past interactions and identified fraud patterns.

By continuously updating and restructuring the IVR pathways of dynamic decision tree 106, system 100 can prevent fraudsters from attacking predictable navigation paths thereby effectively confusing and trapping them in complex loops. Dynamic decision tree 106 may also be configured to adjust routes to avoid congestion or prevent hazards further enabling IVR system 100 to adjust call management strategies to isolate and mitigate potential threats. In other examples, dynamic decision tree 106 may also predict caller needs and potential fraud intent.

Quantum Key Distribution module 108 can generate and manage encryption keys for secure communications in IVR system 100. Quantum Key Distribution module 108 utilizes the principles of quantum mechanics to encrypt and decrypt communication ensuring that only the intended recipients can understand the information and ensures that any attempt to intercept the communications is immediately detectable. Quantum encryption offers a level of security far beyond current SSL/TLS protocols. Quantum Key Distribution module 108 ensures all IVR system 100 communications are fully encrypted from initiation to conclusion, safeguarding sensitive data throughout the transmission process. Quantum Key Distribution module 108 is configured to seamlessly integrate with existing telecommunications technologies while preparing for future quantum-resistant networks.

As also shown in FIG. 1, secure isolation sandbox 110 may include fraud detection and routing protocols that permit real-time analysis of call metadata and content that identifies deviations from normal behavior to facilitate isolation of potential threats. As explained above, calls exhibiting unusual patterns can be routed to a secure sandbox environment 110, minimizing the risk of data breaches. In addition, enhanced analysis tools can provide advanced forensic capabilities for post-incident investigation and algorithm refinement. Enhanced tools can detect, isolate, and respond to threats autonomously, ensuring rapid and effective fraud mitigation. Detailed forensic tools may also provide the ability to conduct an in-depth analysis of fraud attempts, aiding in developing new defenses against emerging threats. Finally, a continuous improvement loop can utilize prior interaction data to refine detection algorithms, enhancing IVR system 100 intelligence and response accuracy.

Feedback and adaption mechanism 112 can implement a sophisticated data analytics framework that continually utilizes machine learning to refine system 100 and AI engine 104 fraud detection algorithms. As new types of fraud emerge, feedback and adaption mechanism 112 adapts its algorithms to detect and prevent these novel scams, staying one step ahead of malicious actors.

Feedback and adaption mechanism 112 can leverage real-time data to allow IVR system 100 the ability to make informed decisions about potential threats thereby enhancing overall system responsiveness and efficacy. By also using predictive analytics, feedback and adaption mechanism 112 can use historical and real-time data to forecast potential fraud scenarios, allowing preemptive actions to be taken. Moreover, feedback and adaption mechanism 112 may use behavior modeling of a known customer/caller that can model a typical user behavior to identify deviations that may indicate fraud thereby improving detection precision.

As described above, IVR system 100 may include electronic counter measure mechanism 114 to disrupt bot attacks by deploying targeted high-frequency signals to disable bots without affecting human callers, to ensure operational safety of IVR system 100 and neutralizing malicious attacks. In some examples, the electronic counter measure mechanism 114 may use precise targeting that only impacts malicious electronic components thereby preserving the integrity of legitimate calls. Electronic counter measure mechanism 114 may activate immediately upon bot detection to mitigate potential data breaches as swiftly as possible. In some examples, electronic counter measure mechanism 114 may include a targeted signal generator that emits specific high-frequency sounds designed to disrupt electronic components within bots and bot electronic components. Importantly, the high-frequency or EMP may only target and disrupt the threat while staying below a threshold as to not harm humans as well as below a threshold that does not harm internal electronics of IVR system 100. When IVR system 100 identifies a call as originating from a bot, the electronic counter measure mechanism 114 can deploy a high-frequency sound that disrupts the operational capabilities of a bot thereby effectively neutralizing the bot while simultaneously being non-destructive to humans, communication systems, and IVR system 100.

Machine Learning as used in this disclosure generally refers to automating and improving the learning process of computers based on their experiences or historical datasets without being actually programmed i.e., without any human assistance. The process starts with inputting good quality data and then training the machines or algorithms by building machine learning models using the data and different algorithms.

Machine learning implementations as used herein are classified into three major categories, depending on the nature of the learning signal or response available to a learning system. The first is supervised learning. This machine learning algorithm consists of a target or outcome or dependent variable which is predicted from a given set of predictor or independent variables. Using these datasets of variables, a function is generated that maps input variables to desired output variables. The training process continues until the model achieves a desired level of accuracy on the training data. Examples of supervised learning include: Regression, Decision Tree, Random Forest, KNN, Logistic Regression, etc.

The second is unsupervised learning. In this machine learning algorithm, there is no target or outcome or dependent variable to predict or estimate. It is used for clustering a given data set into different groups. Apriori algorithm and K-means are some of the examples of Unsupervised Learning.

The third is semi-supervised or reinforcement learning. Using this algorithm, the machine is trained to make specific decisions. Here, the algorithm trains itself continually by using trial and error methods and feedback methods. This machine learns from past experiences and tries to capture the best possible knowledge to make accurate decisions. Markov Decision Process is an example of semi-supervised machine learning.

As described above, machine learning can be used to provide continuous feedback and adaptation in the systems and methods disclosed herein. Machine learning can be used to continuously update the AI models described above based on new fraud patterns to stay ahead of emerging threats. Machine learning can also be used to forecast potential fraudulent behavior using historical and real-time data, allowing for proactive defense measures. Additionally, machine learning may be used to track and analyzes user behavior to establish a baseline to improve the accuracy of fraud detection.

As shown in FIG. 2, an exemplary flow chart is depicted of process 200 for detecting and mitigating fraudulent activities in real-time in the IVR system disclosed herein. Some or all of the steps of process 200 may be performed using any of the computer machines and/or user/client systems described herein. In a variety of embodiments, some or all of the steps described below may be combined and/or divided into sub-steps as appropriate, and some or all of the steps described below may be performed in a different order.

At step 202, IVR system 100 receives an incoming call and the caller voice is analyzed at step 204 by AI engine 104. As previously discussed, caller voice data may include voice tone, voice speed, voice volume, voice patterns indicative of psychological stress, anxiety, hesitation, etc.

At step 206, the caller voice data is processed after analyzing to identify malicious bots or indications of a fraud attack.

At step 208, the dynamic IVR decision tree 106 alters the caller navigation based on detected threats.

At step 210, the identified malicious bots or threats are disrupted by electronic counter measure mechanism 114 that emits targeted high-frequency and non-lethal sounds.

At step 212, the feedback adaptor mechanism 112 refines the AI and fraud detection algorithms of AI engine 104 using real-time feedback, historical data, and machine learning.

At step 214, Quantum Key Distribution module 108 encrypts all data in process 200 to ensure end-to-end encryption of all communications with the caller and IVR system 100 during steps 202 through 218.

At step 216, the fraud indicators and related data may be stored in a quantum-encrypted database of IVR system 100 and the process is completed at step 218.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, and the like that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid-state memory, RAM, and the like. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a system, and/or a computer program product.

Although the present invention has been described in certain specific aspects, many additional modifications and variations would be apparent to those skilled in the art. In particular, any of the various processes described above may be performed in alternative sequences and/or in parallel (on different computer machines) in order to achieve similar results in a manner that is more appropriate to the requirements of a specific application. It is therefore to be understood that the present invention may be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A secure and adaptive Interactive Voice Response (IVR) system for detecting and mitigating fraudulent activities in real-time comprising:
an Artificial Intelligence (AI) analysis engine configured to evaluate caller voice data to identify malicious bots and to detect fraud indicators via fraud detection algorithms;
a dynamic IVR pathway configured to modify caller navigation routes to isolate calls with detected fraud indicators in real-time;
an electronic countermeasure mechanism configured to disrupt the malicious bots;
a feedback and adaptation mechanism configured to refine the AI analysis engine and related fraud detection algorithms utilizing machine learning; and
a Quantum Key Distribution (QKD) module configured to provide secure communications within the system.

2. The system of claim 1, wherein the caller voice data comprises voice tone, voice speed, voice volume, or voice patterns indicative of psychological stress, anxiety, or hesitation.

3. The system of claim 1, wherein the caller voice data is compared to a known customer profile to detect fraud.

4. The system of claim 1, wherein the caller voice data is compared to known fraudulent profiles to detect fraud.

5. The system of claim 1, wherein the AI analysis engine is further configured to perform behavioral pattern recognition that compares a known customer profile to a known fraudulent profile to distinguish between a legitimate caller and a malicious caller.

6. The system of claim 1, wherein the modified caller navigation routes prevent a fraudster from attacking predictable navigation paths by confusing and trapping the fraudster in a complex loop.

7. The system of claim 1, wherein the electronic countermeasure mechanism is configured to emit a targeted high-frequency signal to disable the malicious bots.

8. The system of claim 7, wherein the targeted high-frequency signal does not impact or harm a human caller.

9. The system of claim 1, further comprising a sensor configured to detect caller facial expressions.

10. The system of claim 9, wherein the AI analysis engine is further configured to identify detected caller facial expressions comprising fraud indicators.

11. A method of fraud protection in an Interactive Voice Response (IVR) system, comprising:
receiving an incoming call from a caller via the IVR system and initiating an analysis of a caller voice data via an Artificial Intelligence (AI) engine;
processing the caller voice data to identify malicious bots and to identify fraud indicators via fraud detection algorithms;
modifying caller navigation routes to isolate calls with detected fraud indicators in real-time via a dynamic IVR pathway;
disrupting identified malicious bots via an electronic countermeasure mechanism;
refining the AI engine and related fraud detection algorithms via a feedback and adaptation mechanism utilizing machine learning;
encrypting communications between the caller and the IVR system using Quantum Key Distribution (QKD); and
storing the detected fraud indicators via a quantum-encrypted database.

12. The method of claim 11, wherein the caller voice data comprises voice tone, voice speed, voice volume, or voice patterns indicative of psychological stress, anxiety, or hesitation.

13. The method of claim 11, wherein the caller voice data is compared to a known customer profile to detect fraud.

14. The method of claim 11, wherein the caller voice data is compared to known fraudulent profiles to detect fraud.

15. The method of claim 11, wherein the electronic countermeasure mechanism is configured to emit a targeted high-frequency signal to disable the malicious bots.

16. The method of claim 15, wherein the targeted high-frequency signal does not impact or harm a human caller.

17. The method of claim 16, wherein the human caller cannot hear the targeted high-frequency signal.

18. The method of claim 11, further comprising the step of detecting, via a sensor, caller facial expressions.

19. The method of claim 18, wherein the AI analysis engine is further configured to identify detected caller facial expressions comprising fraud indicators.

20. A non-transitory machine-readable medium storing instructions for fraud protection in an Interactive Voice Response (IVR) system that, when executed by one or more processors, cause the one or more processors to perform steps comprising:
receive an incoming call from a caller in the IVR system;
initiate an analysis of a caller voice data via an Artificial Intelligence (AI) engine;
process the caller voice data to identify malicious bots and to identify fraud indicators via fraud detection algorithms;
modify caller navigation routes to isolate calls with detected fraud indicators in real-time via a dynamic IVR pathway;
disrupt identified malicious bots via an electronic countermeasure mechanism;
refine the AI engine and related fraud detection algorithms via a feedback and adaptation mechanism utilizing machine learning;
encrypt communications between the caller and the IVR system using Quantum Key Distribution (QKD); and
store the detected fraud indicators via a quantum-encrypted database.
